(19) United States
(12) Patent Application Publication
(10) Pub. No.: US 2006/0288866 A1
(43) Pub. Date: Dec. 28, 2006

(54) Application of sonic particle scavenging process to threat aerosols

(76) Inventors: Jay B. Cleckler, Long Beach, CA (US); Todd G. Clements, Seal Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/447,580

(22) Filed: Jun. 6, 2006

Related U.S. Application Data
(60) Provisional application No. 60/688,017, filed on Jun. 7, 2005.

(51) Int. Cl. B03C 3/00

(52) U.S. Cl. 95/78

(57) ABSTRACT

A process and a system applying sonic particle scavenging to threat aerosols, particularly threat aerosols of chemical and biological origin, in both confined and unconfined, open air situations. The effectiveness of sonic particle scavenging is improved by adding a secondary aerosol that neutralizes chemical and biological aerosol particles upon impact therewith. The neutralizing aerosol also serves to increase the total amount of aerosol interactions. Preferably, the neutralizing aerosol is dispersed into the region containing the threat aerosols, followed by activating a high-power acoustic source to generate high-power sound waves, which drives particles of the threat aerosol into each other as well as neutralizing aerosol particles. Thereby, the majority of threat aerosol particles are neutralized and/or the threat aerosol particle size is increased. Threat particle of increased size often precipitate (rain-out). As the particle size is dramatically increased, even those threat particles which have not precipitated, and/or become neutralized will become irrespirable and more easily defeated by clothing and aerosol filtration devices.

### CROSS-REFERENCE TO RELATED APPLICATIONS

The present utility patent application is related and claims priority to U.S. Provisional Patent Application 60/688,017, filed Jun. 7, 2005, entitled APPLICATION OF SONIC AGGLOMERATION TO THREAT AEROSOLS, the teachings of which are expressly incorporated by reference.

### STATEMENT RE: FEDERALLY SPONSORED RESEARCH/DEVELOPMENT

Not Applicable

### BACKGROUND

The current invention relates in general to a system and a method for treating threat aerosols, and more particular, to a system and a method to neutralize and defeat threat aerosols by sonic agglomeration.

Chemical and biological aerosols pose a risk to national security through both potential terrorist releases and as a result of industrial accidents. A threat aerosol is a collection of small solid and/or liquid particles suspended in air that constitutes a hazard to people or property. The particles comprising threat aerosols are thus termed threat particles. Threat particles are hazardous primarily because they are made of materials that are poisonous, infectious, corrosive or otherwise deleterious to health and/or property. Threat particles are also hazardous due to their small size and the corresponding ease with which they can move into the body.

Many chemicals within the current art are capable of neutralizing all forms of hazard embodied in the matter composing threat particles, provided direct and extended contact with the matter and said decontaminating chemicals. The general category of these decontaminating, or neutralizing, chemicals are defined hear as counter-agents. Within the art are many counter-agents and processes detailing their use, capable of or decontaminating hazardous materials when such materials are collected on surfaces, or in containers. However, when hazardous material is suspended in air as a threat aerosol, it is very difficult for counter-agents to make contact with threat particles. In a threat aerosol particles are spaced to such an extent that they can not collide with counter-agent at a sufficient frequency to enable acceptable reduction of the hazard posed. What is required is a process through which the collision rate of threat particles and counter-agent can be increased.

A process for reducing or eliminating the hazards of threat aerosols would have applications in many areas. One such application specific to this patent is the interdiction of harmful chemical or biological aerosols released by terrorists or industrial accidents. Such a process may also prove effective at reducing damage caused by smoke in fires.

### BRIEF SUMMARY

The current invention seeks to address the aforementioned deficiencies and relates specifically to the generation of a counter-agent aerosol, whose constituent counter-agent particles are capable of neutralizing, either in full or in part, threat particles provided direct collision, and a method for using sound waves to increase the rate at which these collisions occur. Both sound waves and the turbulent exhaust often generated as a product of making intense sound waves are used in this invention to increase the said collision rate. The generation of a counter-agent aerosol into a region containing a threat aerosol and the subsequent use of sound waves, and the products of making sound waves, to generate collisions amongst all the constituent particles comprises a process; here called sonic particle scavenging. The process titled sonic particle scavenging includes, as subsets, related processes involving different relative amounts of counter-agent particles and threat particles, including the use of no counter-agent particles. However, the introduction of counter-agent particles into a threat aerosol increases the overall effectiveness of the process and is a specific feature of this invention.

Sound waves, particularly very intense sound waves, cause each aerosol particle to move forward and then backward in a repeating cycle. This cycle can be controlled, primarily through variable aspects of the sound waves, so as to make aerosol particles run into one another. The collisions that occur due to these oscillations would be similar to collisions that would occur amongst cars on a freeway if they were caused to move rapidly back and forth across lanes. The turbulent exhaust products that result, in most cases, from making high power sound also serves to increase the collisions among all particlcs. Of the collisions that occur among all particles there are three categories; collisions among counter-agent particles and threat particles, collisions among counter-agent particles and other counter-agent particles and collisions among threat particles and other threat particles. When aerosol particles collide they almost always stick together to form new, larger particles. The collision of particles and their subsequent combination into larger particles is known within the art as agglomeration. Agglomeration of counter-agent particles with threat particles results in neutralization of threat particles. The agglomeration of threat particles with other threat particles results in larger threat particles. As threat particles become larger they become less dangerous because their ability to move into the lungs is reduced. Moreover, continued agglomeration often results in particles so large that they can no longer be suspended in the air and are thereby induced to rain out. Thus the methods by which the sonic particle scavenging process reduces the hazards posed by threat aerosols are threefold; the direct neutralization of threat particles, the growth of threat particles and the subsequent reduction of said particles ability to enter the lungs and, thirdly, the growth of massive particles that rain out of the air.

The methods of generating collisions among particles using acoustics and turbulence is known within the art, but the combination of acoustic and turbulence induced collisions among particles is unique to this invention. Also the process of injecting a counter-agent aerosol into a threat aerosol and the subsequent use of acoustic waves and turbulence to enhance collision rate is unique to this invention.

The sonic particle scavenging process so described has demonstrated the ability to neutralize more than 99.99% of a threat aerosol. The sonic particle scavenging process has also demonstrated the ability to rain out more than 99.9% of a threat aerosol.

The sonic particle scavenging process has been conceived, optimized and reduced to practice by the authors. A device for generating the necessary sound waves, and in doing so, producing turbulent exhaust products, has also has also been conceived and reduced to practice. This device is described in Provisional Patent Application Ser. No. 60/688,278, filed on Jun. 7, 2005, entitled COMPACT HIGH-POWER ACOUSTIC TONE GENERATOR by the same inventor, and the disclosure of which is incorporated herein in its entirety by reference. Additionally provided are the teachings of U.S. Provisional Patent Application 60/688,017, filed Jun. 7, 2005, entitled APPLICATION OF SONIC AGGLOMERATION TO THREAT AEROSOLS, which are likewise expressly incorporated herein by reference.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an illustration of the sonic particle scavenging process using neutralizing secondary particles;

FIG. 2 shows a laboratory experiment for proving the merits of sonic particle scavenging;

FIG. 3 shows the aerosol concentration as a function of time in the effect of sonic particle scavenging;

FIG. 4 shows an exploded and cross-sectional view of a sonic particle scavenging device; and

FIG. 5 shows an application of the sonic particle scavenging process;

### DETAILED DESCRIPTION

There are many ways to generate agglomeration; however, the use of intense acoustic waves and the turbulent exhaust products that result from making intense acoustic waves, have proved to be the most successful among these. To reference the rapidity at which intense sound causes aerosol particles to agglomerate, it is useful to summarize the most common mechanism within the art; thermal agglomeration. Thermal agglomeration involves the random motion of particles due to the continual bombardment of molecules in the suspending gas. This type of random motion is known within the art as Brownian motion. All aerosol particles suspended in a gas are imbued with Brownian motion. Within the art, collision and the subsequent combination of particles due to Brownian motion is referred to as thermal agglomeration. For aerosols consisting of only one size of particle, the number concentration, N(t), of aerosol particles undergoing pure thermal agglomeration obeys the equation:

$$N ( t ) = \frac{{N}_{o}}{1 + {N}_{o} {K}_{o} t}$$

In this equation Kₒ is the diffusion coefficient:

$${K}_{o} = \frac{4 {kTC}_{c}}{3 v} ,$$

where T is the absolute gas temperature, k is Boltzmann's constant, v is the dynamic viscosity and C_{c} is the mean free path slip correction factor. For an aerosol consisting of particles of 5 microns diameter, a mass concentration of 7 g/m³ and a temperature of 20 degrees Celsius, it would take over 83 hours to reduce the aerosol number concentration by a factor of ten. The agglomeration rate can be enhanced by increasing temperature and using an aerosol consisting of both very large and very small particles. Nonetheless, the time required to reduce particle concentration cannot be decreased practically by more than a factor of 100 and it is not always possible to specify threat particle sizes. This level of reduction and time span are insufficient for most applications, particularly applications involving the terrorist or industrial accident release of chemical or biological aerosols.

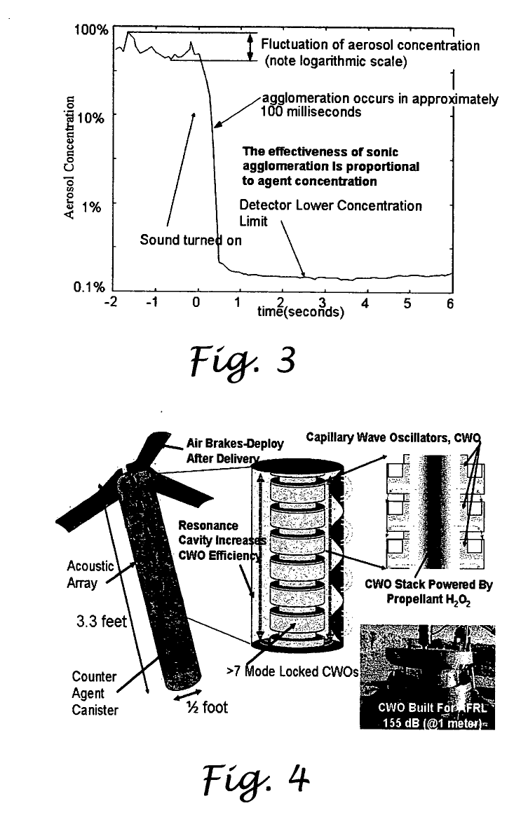

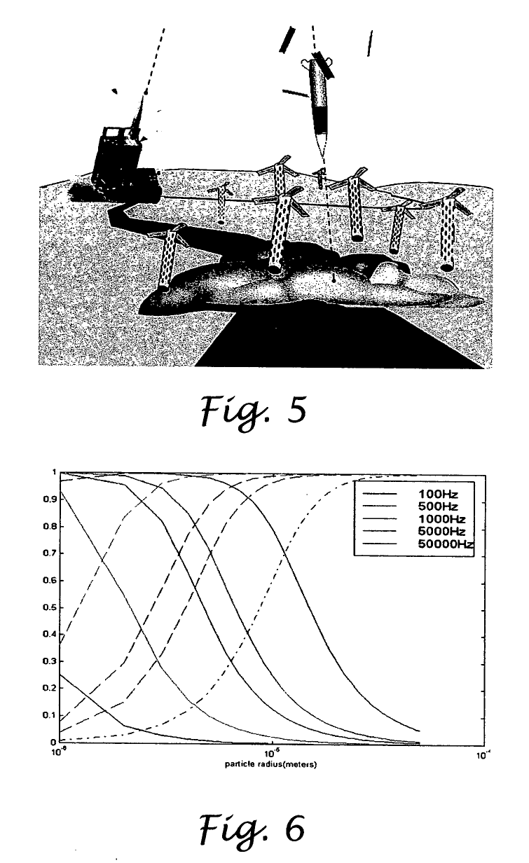

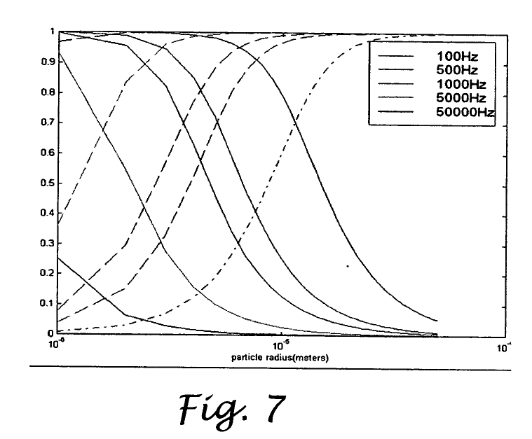

By contrast the collision rates induced by sonic agglomeration are very high. To verify the effect of sonic agglomeration in the context of a chemical threat aerosol release, an apparatus comprising a standing wave resonance tube, a modified driver acoustic source and opacity diagnostic is provided as shown in FIG. 2. In this experiment, chemical threat aerosol with a specified eight micron mass median particle diameter was sprayed into the test chamber in excess of 1 g/m³. Concentration is measured using laser instrumentation and methods established within the art. Sound waves with approximate amplitudes of 630 Newton per square meter induce the aerosol to quickly rain out. Typically complete rain out, under these conditions, is achieved in less than 100 milliseconds, as illustrated in FIG. 3. The addition of counter-agent particles further enhances the effect

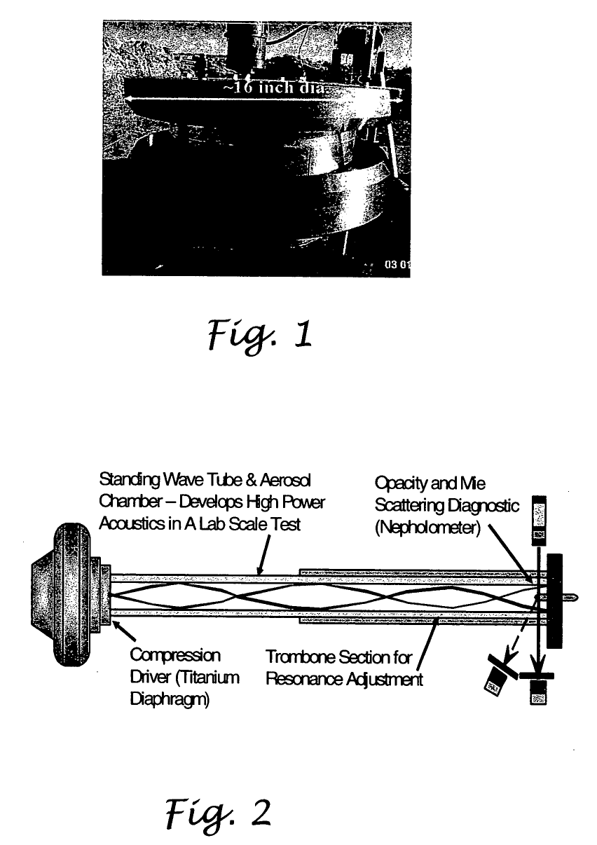

The sonic particle scavenging process has been reduced to practice in large scale outdoor and indoor settings using the acoustic device described in Provisional Patent Application Ser. No. 60/688,278, filed on Jun. 7, 2005, entitled COMPACT HIGH-POWER ACOUSTIC TONE GENERATOR by the same inventor of the present application, and the disclosure of which is incorporated herein in its entirety by reference. As shown in FIG. 1, when a threat aerosol cloud is generated, the acoustic device is preferably delivered to the center of the threat areosol cloud to inject a counter-agent using a range of injection techniques. The turbulent byproduct of the aerosol injection is then used to achieve overall mixing of the counter-agent and the threat aerosol clouds. After completion of mixing, an intense sound is generated to drive threat and counter-agent particles together and to drive threat particles into other threat particles.

The acoustic device and aerosol injection device necessary to produce the sonic particle scavenging process can be mounted on a helicopter or other air vehicles. Likewise, it can be dropped into the cloud from an air vehicle, or artillery rocket. It can also be hand emplaced or carried to the threat cloud on a ground vehicle.

In event of a terrorist threat aerosol release, particularly a chemical or biological aerosol release, the sonic particle scavenging process could be used to reduce the overall hazard posed by such a release. This may be done with devices capable of producing sound and injecting_ counter-agent aerosol, particularly the invention described in a related patent (reference patent) and counter-agent injection devices well known within the art, delivered to a point above the cloud. The counter-agent aerosol would then be injected and mixed into the threat aerosol cloud. The acoustic device would then proceed downward through the cloud using a parachute or streamer, generating particle collisions among the combined aerosol cloud surrounding it. Thereby the sonic particle scavenging process would be capable of treating a terrorist release of threat aerosol, particularly the release of a chemical or biological aerosol. A similar treatment could be provided to a threat aerosol release emanating from an industrial accident.

The theoretical description of sonic agglomeration is further provided as follows.

The sonic particle scavenging process may be approximated by complicated sets of equations. The equations,

$$\begin{matrix}\frac{\partial {N}_{A} ( {V}_{y} )}{\partial t} + \vec{v} \cdot ∇ {N}_{A} ( {V}_{y} ) = \frac{1}{2} {\int }_{0}^{{V}_{y}} {K}_{A , A} ( {V}_{y} , {V}_{x} , \hat{p} ) {N}_{A} ( {V}_{x} ) {N}_{A} ( {V}_{y} - {V}_{x} ) ⅆ {V}_{x} - \\ {N}_{A} ( {V}_{y} ) {\int }_{0}^{∞} {K}_{A , A} ( {V}_{y} , {V}_{x} , \hat{p} ) {N}_{A} ( {V}_{x} ) ⅆ {V}_{x} - \\ {N}_{A} ( {V}_{y} ) {\int }_{0}^{∞} {K}_{A , C} ( {V}_{y} , {V}_{x} , \hat{p} ) {N}_{B} ( {V}_{x} ) ⅆ {V}_{x} + \\ {D}_{A} ( {V}_{y} ) {∇}^{2} {N}_{A} ( {V}_{y} ) - {α}_{A} ( {V}_{y} ) {N}_{A} ( {V}_{y} )\end{matrix}$$

specify how the concentration of threat particles, N_{A}, changes in time. N_{A} is a function of particle size, V_{y}, and an implicit function of space and time. There is one such equation for every particle size and thus the above expression represents an infinite set of equations. The first term in this equation represents the time change in the threat particle concentration of size V_{y}; the second term represents the effects of winds upon the same threat particle concentration. The first term on the right represents particle concentration gained among particles of size V_{y}, due to collisions among smaller particles. The factor K is termed the collision kernel and specifies how sound waves cause particles of various sizes to run into one another. The collision kernel is a function of the sound wave properties as well as the sizes of particles participating in each collision. Representations for the collision kernel for turbulent and sonic agglomeration may be found in the art, but these representations have not been found to work adequately for this invention. For this invention the collision kernel, K, for sonic and turbulent agglomeration has been developed using empirical techniques and may be represented in terms of a large table. The second term on the right represents depletion of particles of size V_{y} due to collisions with other particles. The third term represents neutralization of threat particles due to collisions among threat and counter-agent particles. The fourth term represents diffusion of the size V_{y} threat particles. The fifth term estimates the fall-out of particles of size V_{y}.
A mathematically similar set of equations is defined, describing these same phenomena, for counter-agent particles:

$$\begin{matrix}\frac{\partial {N}_{CA} ( {V}_{y} )}{\partial t} + \vec{v} \cdot ∇ {N}_{A} ( {V}_{y} ) = \frac{1}{2} {\int }_{0}^{{V}_{y}} {K}_{CA , CA} ( {V}_{y} , {V}_{x} , \hat{p} ) {N}_{CA} ( {V}_{x} ) {N}_{CA} ( {V}_{y} - {V}_{x} ) ⅆ {V}_{x} - \\ {N}_{CA} ( {V}_{y} ) {\int }_{0}^{∞} {K}_{CA , CA} ( {V}_{y} , {V}_{x} , \hat{p} ) {N}_{CA} ( {V}_{x} ) ⅆ {V}_{x} - \\ {N}_{A} ( {V}_{y} ) {\int }_{0}^{∞} {K}_{A , CA} ( {V}_{y} , {V}_{x} , \hat{p} ) {N}_{A} ( {V}_{x} ) ⅆ {V}_{x} + \\ {D}_{CA} ( {V}_{y} ) {∇}^{2} {N}_{CA} ( {V}_{y} ) - {α}_{CA} ( {V}_{y} ) {N}_{CA} ( {V}_{y} )\end{matrix}$$

A final equation is defined to describe the acoustic waves produced so as to generate rapid collision among all the particles:
\hat{p}(x,y,z,ω)=−k²∇²\hat{p}(x,y,z,ω)=−(k₁+ik₂)²∇²\hat{p}(x,y,z,ω)
In this equation p is the frequency domain acoustic pressure and k is the wave number. The k component is a complex number, with the imaginary part describing absorption of sound energy by the combined counter-agent and threat aerosol. Absorption requires that the acoustic equation be coupled to the two infinite sets of equations.

The above description is given by way of example, and not limitation. Given the above disclosure, one skilled in the art could devise variations that are within the scope and spirit of the invention disclosed herein, including various ways of generating the high-power acoustic energy and various counter-agents used to neutralize the threat aerosol and to accelerate the sonic agglomeration. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A device for counter-measuring a threat aerosol comprising:
a high-power acoustic device operative to generate high-power acoustic waves to drive particles of the threat aerosol agglomerating together.

2. The device of claim 1, wherein the threat aerosol is additionally agglomerated using the byproduct turbulent exhaust produced in making high power sound waves.

3. The device of claim 2, wherein the threat aerosol includes aerosol released from a chemical or biological weapon.

4. The device of claim 2, further including a device for injecting a counter-agent aerosol for neutralizing the threat aerosol.

5. The device of claim 4, wherein the device is operative to spray the counter-agent aerosol into the threat aerosol to accelerate sonic agglomeration of the threat aerosol.

6. The device of claim 4, wherein the counter-agent is an aerosol.

7. The device of claim 4, wherein the counter-agent is a vapor.

8. A process for counter-measuring and/or treating a threat aerosol, comprising:
dispersing a counter-agent into the threat aerosol; and
applying high-power sound waves to the threat aerosol and the counter-agent.

9. The process of claim 7, wherein the counter-agent is operative to neutralize the threat aerosol.

10. The method of claim 7, wherein the counter-agent is operative to accelerate sonic agglomeration of the threat aerosol particles.

11. The process of claim 7, further comprising using a turbulent byproduct of the step of dispersing of the counter-agent to mix the counter-agent and the threat aerosol clouds.
